(19) United States
(12) Patent Application Publication
(10) Pub. No.: US 2011/0314403 A1
(43) Pub. Date: Dec. 22, 2011

(54) SYSTEMS TO PROVIDE DATA VISUALIZATION AND BUSINESS PROCESS ACTION IN AN ON-DEMAND ENTERPRISE DASHBOARD

(76) Inventor: Nancy Yan, Santa Clara, CA (US)

(21) Appl. No.: 12/820,810

(22) Filed: Jun. 22, 2010

(51) Int. Cl. G06F 3/048

(52) U.S. Cl. 715/772

(57) ABSTRACT

Some aspects include presenting, in a graphical user interface display panel, a graphic visualization of a business metric; and presenting, in the same graphical user interface display panel, a mechanism to initiate a business process action associated with the visualized business metric. Some aspects include providing multiple visualization and levels of detail of the business metric and activating the mechanism to initiate the business process action associated with the visualized business metric in association with the multiple visualization and levels of detail of the business metric.

### FIELD

The present disclosure relates generally to business intelligence dashboards. More particularly, some embodiments relate to providing a business intelligence dashboard including data visualizations and actionable business process components.

### BACKGROUND OF THE INVENTION

Business Intelligence (BI) generally refers to software tools used to facilitate and improve business decision-making based on enterprise data. BI tools may be applied to sourcing, procurement, financial, human resource, marketing, sales, customer, supplier, and other business management analyses. In some aspects, BI can include data warehousing systems for managing information from both internal and external sources, reporting and analysis tools for presenting information, content delivery infrastructure systems for delivery and management of reports and analytics, as well as other capabilities.

A BI dashboard may provide a graphical user interface that enables a user to see key data items or metrics. A dashboard may present business information that a user can use to make business decisions. The dashboard may typically include a number of graphical elements providing a presentation of business metrics. The graphical elements may include charts, indicators, tables, and other graphical data visualization components. A dashboard may present different types of business information. As such, there are different types of dashboards, each of which may be directed to presenting specific types of business information. Example dashboards include operational dashboards, strategic dashboards, and tactical dashboards for presenting operational, strategic, and tactical business information metrics, respectively.

Despite a particular focus of a dashboard, the dashboards all provide data visualizations through their graphical elements. While these data visualization dashboards may provide a presentation or visualization of the relevant business information metrics a user needs to make an informed, educated business decision regarding a business unit, corporation, industry and the like, the user may need to resort to another application, service, or system to execute the action(s) required to implement the business decision.

Accordingly, what is desired is a system to provide a dashboard including data visualization and actionable business process components in an on-demand service-oriented architecture.

### BRIEF DESCRIPTION OF THE DRAWINGS

FIG. 1 is a block diagram of a dashboard according to some embodiments.

FIG. 2 is a flow diagram of a process of combined visualization and actionbility according to some embodiments.

FIG. 3 is a view of a user interface according to some embodiments.

FIG. 4 is a flow diagram of a process according to some embodiments.

FIG. 5 is a flow diagram of a process according to some embodiments.

FIG. 6 is a view of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

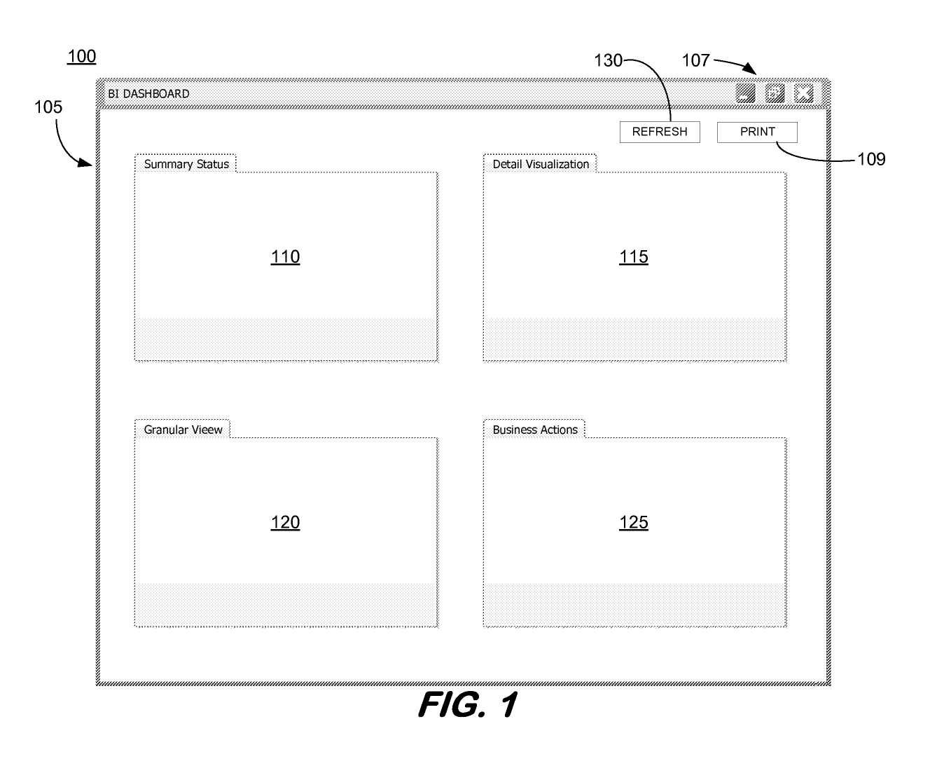

Some embodiments may be implemented using a graphical user interface (GUI) 100 such as that shown in FIG. 1. GUI 100 may include a plurality and variety of graphical icons and visual indicators to represent the information and actions available to a user therefrom. Actions such as the selection, highlighting, activation, and deactivation of the graphical icons may usually be performed through manipulation of the graphical icons by a user manipulating a user input device. The user input device(s) can include a mouse, a keyboard, a keypad, a touchscreen, a voice command, and other user input devices and methods. GUI 100 may be rendered by a web browser or other program, application, or service. GUI 100 will be referred to herein a dashboard. Aspects of the attributes, creation, user interactions, and business actions of the dashboard will be described in greater detail below.

GUI 100 includes a display panel 105. Display panel 105 may include a number of GUI icons 107 and 109 that relate to controllable actions of the GUI itself and one or more display areas 110, 115, 120, and 125. In the present embodiment, display areas 110, 115, and 120 may be used to display or present graphic visualizations of one or more business metrics. Accordingly, these displays areas are also referred to herein as data visualization components.

Data visualization components 110, 115, and 120 may each include graphical representations of business metrics. The graphical representations may include one or more, in combination and alone, charts, indicators, and tables. Charts can include visual presentations of a series of related data values; indicators can include visual presentations of a value's (e.g., a number) position on a scale of values; and tables can include columnar arrangements of data in a business view. Each of the data visualization components 110, 115, and 120 may be related to one or more business contexts such as, for example, a business enterprise, entity, unit, department, and business functions such as procurement, human resources, sourcing, sales, etc.

In some aspects, and as an example, there may be an enterprise on-demand platform that delivers business software as a service to its customers. As part of that delivery, there may be a use case that requires a user, such as a system administrator or other authorized personnel, to monitor users logged into the system based on a number of categories, including but not limited to their country, current usage, historical user activities, etc. (i.e., business metrics). Data visualization components 110, 115, and 120 may include graphical representations to present and display the business metrics associated with the users' country, current usage, historical user activities, etc. In this manner, the system administrator may monitor system user activity in the context of the associated business(es).

In some instances, the system administrator may further desire or need to take some action in response to a status, condition, or relationship of the data visualization data presented and considered (i.e., an analysis) in data visualizations 110, 115, and 120. Based on the analysis of data visualizations 110, 115, and 120, the system administrator may make a business decision and future desire to implement that business decision.

In accordance with some embodiments herein, display area 125 of GUI 100 provides a mechanism for the system administrator to initiate a business process associated with at least one of the business metrics represented in data visualizations 110, 115, and 120. Display area 125 is also referred to herein as a business action component. Graphical and/or additional types of representations may be presented in business action 125 to provide the system administrator with the capability to initiate, invoke, start, activate, or otherwise provide an indication of which action associated with the business process action should be performed.

Execution of a business process may include, but is not limited to, instantiating, populating and manipulating business objects (BOs) within a business process platform. The BOs may comprise a class defining data and methods associated with a business entity. For example, a business process may include creation of an employee business object, an employment business object, a work agreement business object, a compensation agreement business object, a supplier business object, etc., as well as definition of dependencies between these and other BOs. In general, a business process platform may provide services to a client according to some embodiments. Such services may comprise Web services and the client may therefore comprise a Web client. Examples of a Web client include, but are not limited to, a Web browser, an execution engine (e.g., JAVA, Flash, Silverlight) to execute associated code in a Web browser, and a dedicated standalone application.

A business process platform may include software workflow processes, each of which may independently execute tasks required of the business process platform. The business process platform may support more than two simultaneous software workflow processes according to some embodiments. Elements of a software workflow process may execute a business process by manipulating one or more of BOs, each of which is unaware of the overall business process for which it is being manipulated.

The combination of data visualization components 110, 115, and 120 and business action component 125 in the same dashboard provides an efficient method, system, apparatus, and means for the system administrator to monitor and analyze business metrics associated with an aspect of the business, as well as a mechanism to take an action based on the analysis directly from within the dashboard. Accordingly, a dashboard including both data visualizations and business process actions is also referred to as a combined dashboard in some embodiments.

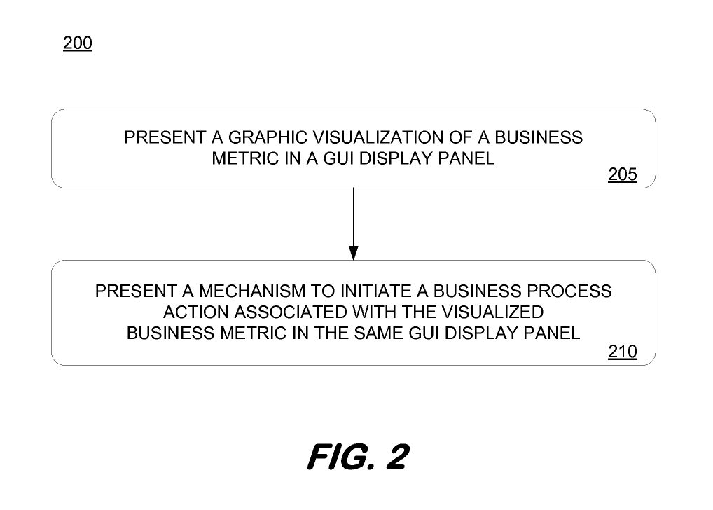

FIG. 2 provides a high level flow diagram of a process 200 according to some embodiments herein. Briefly, process 200 provides a dashboard including a data visualization component and business action component. Process 200 may be performed by systems, apparatuses, and means further described herein, but embodiments are not limited thereto.

Process 200 and all other processes mentioned herein may be embodied in processor-executable program code read from one or more of a tangible computer-readable medium, such as a floppy disk, a CD-ROM, a DVD-ROM, a Zip™ disk, a flash drive, a solid state drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Process 200 and all other processes mentioned herein may are not limited to being performed the particular order or sequence as specifically disclosed.

At 205, process 200 presents a graphic data visualization of a business metric in a GUI display panel. In some aspects, more than one business metric may be represented by the graphical objects. That is, multiple instances of graphic data visualizations may be presented in the GUI and the multiple instances of the graphic data visualizations may each correspond to a graphical object.

Process 210 further discloses a mechanism is presented or displayed in the GUI display panel to initiate a business process action. The business process action is associated with the visualized business metric. Thus, both the data visualization and the business process action are presented or displayed in the GUI and they both relate to the visualized business metric.

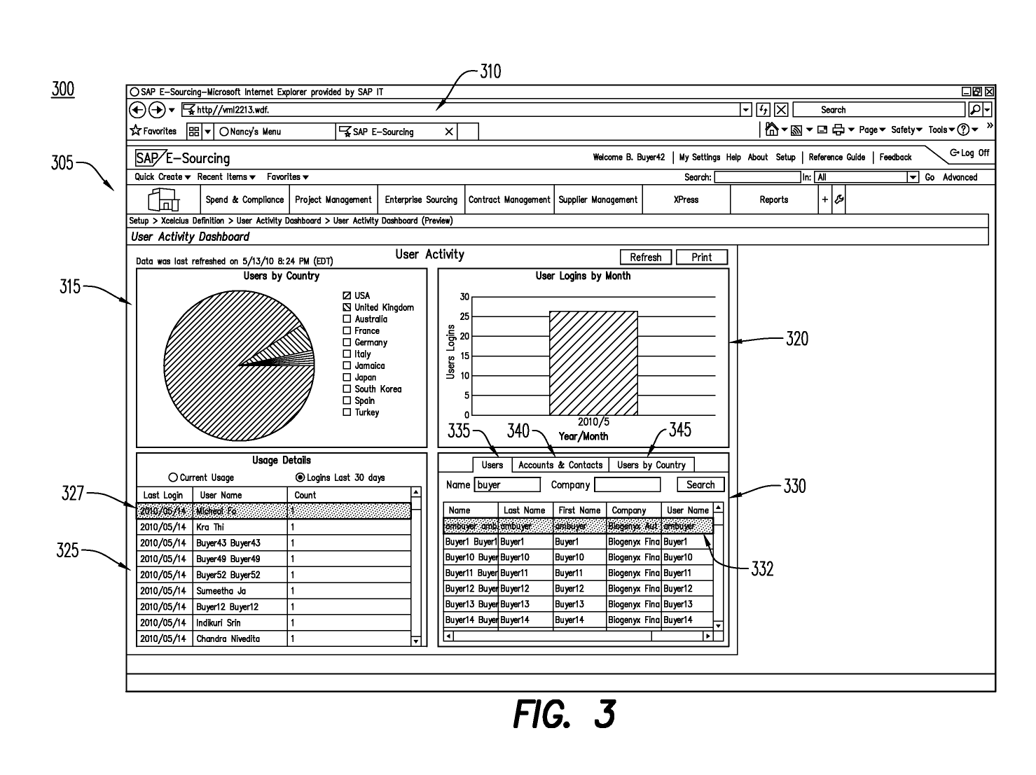

FIG. 3 is a view of a user interface 300 according to some embodiments. In particular, user interface 300 includes a dashboard 305. Dashboard 305 may be referenced for retrieval by an identifier such as a uniform resource locator (URL) 310. Dashboard 305 includes data visualization components 315, 320, and 325; and business process action component 330. Data visualization components 315, 320, and 325 are associated with business metrics. In some embodiments, data visualizations 315, 320, and 325 may be used to navigate, view, and analyze data retrieved from and/or stored at sources within and external a business enterprise.

In the example of FIG. 3, dashboard 305 is related to user activity of an enterprise. Data visualization component 315 provides an overall summary status of the user activity. As shown, data visualization component 315 presents a pie chart with indications of users by country, where each country may be depicted by a different color. Data visualization component 320 provides a detail visualization of artifact(s) associated with one or more of the business metrics depicted in the summary status data visualization 315 associated with the business metrics. In this example, and not limited thereto, detail visualization 320 presents a bar graph with indications of user logins by month for a particular country represented in summary status data visualization 315. As demonstrated, detail visualization 320 provides a detailed view or insight into the associated business metric artifacts initially summarized by the summary status data visualization 315. Detail visualization 320 may, in some embodiments, depict the details of the business metric(s) shown therein in manner consistent with the summary status data visualization 315. For example, the color coding of detail visualization 320 may be held consistent with summary status data visualization 315.

Dashboard 305 also includes a granular view data visualization component 325, which presents or displays a granular view of one or more of the artifacts associated with the business metrics, as presented in the detail visualization component 320. As shown, granular view data visualization 325 provides a representation of specific users that were visualized in the detail visualization 320. Specific items may be selected for further review and analysis, such as is the case with the selected user name shown at 327.

Business process action component 330 includes one or more mechanisms to perform a business process associated with data visualizations (e.g., 315, 320, and 325) directly from dashboard 305. A user may initiate, invoke, start, or otherwise take an action by selecting or otherwise indicating an activation of a graphical object in the business process action component 330. As illustrated, the user of dashboard 305 may highlight or select a user 332 of the dashboard in order to perform an action related to the selected user. Selection of the business process action 332, in some aspects, may result in, for example, activating a user based on their visualized data, deactivating the user, rewarding the user, and/or expanding (contracting) the user's rights based on the user's historical usage, as illustrated in the data visualization aspects 315, 320, and 325.

In some aspects, the combined dashboards herein including both data visualization and business action components may be implemented with layouts and configurations other than those specifically shown in FIGS. 1 and 3. For example, in some instances the data visualization and business action components of a combined dashboard may, in whole or in part, be layered. In some aspects, layered display panels containing one or more of the data visualization and business action components may be tabbed (e.g., FIG. 1), with a first display panel fully displayed in the combined dashboard and one or more of the other display panels at least partially obscured or covered by the first display panel. The identifying tabs of the at least partially obscured display panels may be visible and selectable by a user of the combined dashboard for interaction therewith.

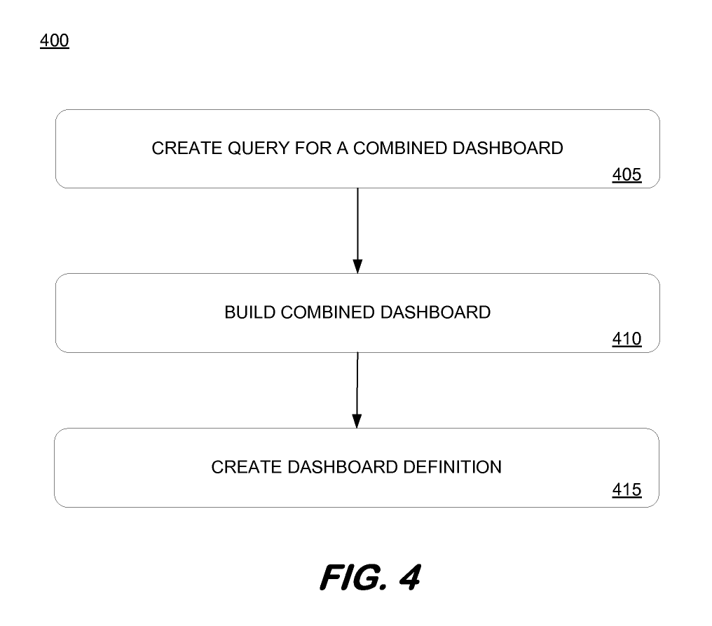

FIG. 4 is a flow diagram of a process 400 according to some embodiments. In particular, process 400 is a design time process for creating a combined dashboard according to some embodiments having both data visualization components and business process action components. Process 400 may be utilized by developers and/or service users to create a combined dashboard in accordance with some embodiments. In some aspects, the combined dashboard may be created using a dashboard and presentation application, software, or service (e.g., BusinessObjects Xcelsius).

At operation 405, a developer may define the queries that will be used by the combined dashboard being created. As such, the developer should have an understanding of both the data visualizations, as well as the business logic data to be contained in the dashboard. In some instances, the dashboard requirements may be provided to the combined dashboard developer in a set of requirements, instructions, or other specifications. The dashboard requirements should sufficiently specify the data that is to be used and/or consumed for the data visualizations and the business logic. Part of query definition operation 405 may include specifying the data sources to be accessed in executing the queries at a run time, including specifying a unique identifier associated with the data sources. The number of queries defined may not be limited to a set number. In some embodiments, the queries may specify and access more than one data source, BO, and other data constructs both internal and external of a business enterprise. An application, program, platform, or service may be used for query definition operation 405.

In some embodiments, the business logic of a combined dashboard herein may include the data used in the data visualization components and the “triggers” invoked by activating the business process action components of a combined dashboard. Data for the data visualization components may include data accessed and used in presenting and displaying, for example, data visualization components 110, 115, and 120. The business logic for the business process actions of a combined dashboard may include, for example, application programming interface (API) calls, web services, and remote function calls (RFCs) that are triggered by the selection and/or otherwise activation of the business process actions presented in the combined dashboard.

At operation 410, the combined dashboard is built using a dashboard design and presentation application, service, or program. The dashboard design and presentation application receives the query definitions from operation 405 and maps the query IDs to a data source. Using the dashboard design and presentation application, service, or program, a combined dashboard is created incorporating the specified queries. In some aspects, a preview of the dashboard being created may be provided to the developer to confirm and/or modify the presentation including the graphic elements therein, layout, and other design considerations of the dashboard. In some aspects, no data is accessed or retrieved during the dashboard preview process.

Operation 415 may further include exporting the newly designed dashboard in a file format for further processing, versioning, packaging, or delivery. In some embodiments, the dashboard may be exported as a “.swf' file. However, the embodiments herein are not limited to one particular exporting the dashboard file in the “.swf' (i.e., “Flash”) format or any other one file format. Other file formats suitable and/or capable of containing graphics, multimedia, animation, and applets including varying degrees of interactivity and functionality may be used.

Flow 400 continues with creating a dashboard definition at 415. Dashboard definition 415 provides a wrapper for the metadata of the created combined dashboard. The metadata associated with the combined dashboard may typically specify the graphic element(s) attributes including image and video properties, layout and size properties, etc. In some aspects, the dashboard definition may provide a content management control for the dashboard by further specifying access rights associated with the dashboard. Access rights may include, for example, a listing of who can access the dashboard by including the persons, company, business unit, etc. that can access the dashboard and in the instance of no specified entity, allowing access by all.

As used herein, the term report refers to information automatically retrieved (i.e., in response to computer executable instructions) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a presentation document, and the like.

A report document is a business object in which layout specification and reference of dashboards are persisted. A report document may be provided as a container for rendering a combined dashboard with data visualization and actionable components. One or multiple dashboards can be embedded in a report document.

In some aspects, operation 415 includes using the dashboard definition to create a dashboard report. Typically, this may comprise a wrapper that concerns the rendering of the user interface of the dashboard since the metadata defining the dashboard is contained in the dashboard definition (i.e., wrapper). The metadata defined in dashboard definition can be internal id, description, width, height, source file, Flash file(i.e., swf) and so on.

In some embodiments, the combined dashboard definition created at 415, including all metadata for running the combined dashboard, is exported for deployment, upgrade and use at a run time. In some embodiments, the combined dashboard may be exported in an “.xml” file format. However, file formats other than “.xml” are included within the scope of the embodiments herein.

Operation 415, in some aspects, may include exporting the dashboard in a binary code. This feature may provide a measure of versioning control to combined dashboard creation process 400. In this manner, the combined dashboard is not saved as Flash (i.e., .swf) file for direct rendering but in binary. The binary is saved as BLOB (i.e., binary large object) in a database. The tracking of the binary elements and attributes may be maintained to provide an effective and efficient version control of the combined dashboard.

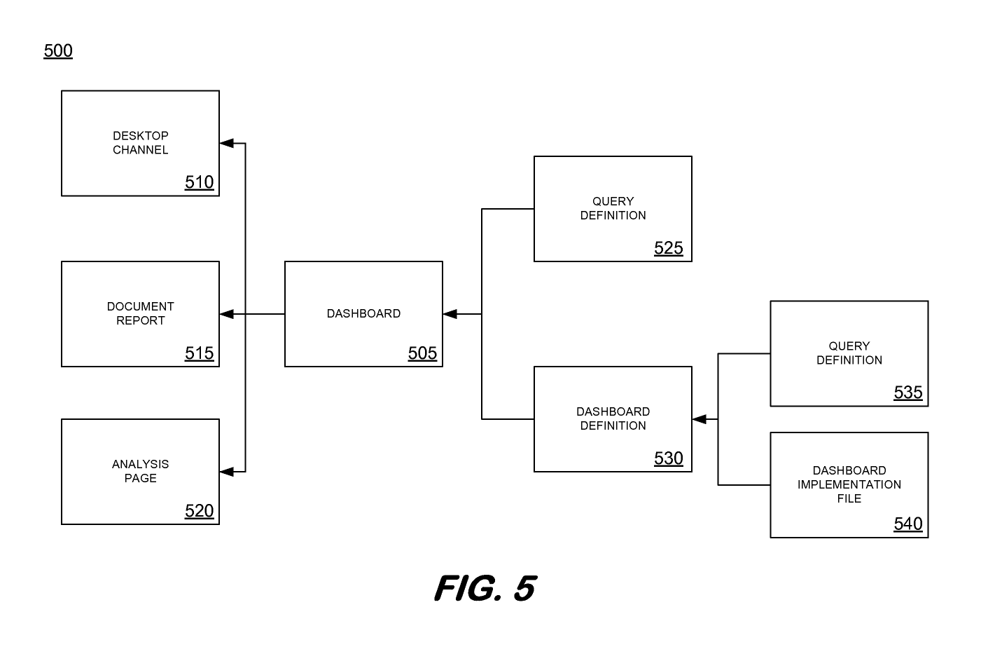

FIG. 5 is a flow diagram of a process according to some embodiments. In particular, process 500 is a run time process for users to view and interact with a combined dashboard according to some embodiments having both data visualization components and business process action components. Process 500 may be utilized by users having rights to access and interact with the combined dashboard. In some embodiments, process 500 may be used to interact with combined dashboards created according to process 400. It is noted that the user need not be aware of or familiar with the design or creation aspects of the combined dashboard.

At operation 505, a user, such as an enterprise on-demand application user may log in to access an enterprise platform supporting the viewing of the combined dashboard 505. The platform may retrieve and load a dashboard report defining the data visualizations and business logic, including the business process actions of the combined dashboard selected by the user. In some aspects, dashboard 505 may be accessed via number of access points. Three such access points 510, 515, and 520 are depicted in FIG. 5, although the three depicted are not meant to be an exhaustive or all encompassing representation of the potential access points compatible with embodiments herein.

Access point 510 includes a desktop channel. Desktop channel 510 may include a main or top-level user web portal at the user's desktop (e.g., client side) and function as a “home page” for an application. Desktop channel 510 may be customized to include a number of pointers to combined dashboards frequented by the user. Document report 515 is another access point for accessing the combined dashboard 505. In some aspects, the document report may be retrieved or delivered as any other business object report document. In some instances, analysis page 520 may provide an entry into dashboard 505. In the process of viewing a page listing multiple analytics regarding a business unit or entity, the user may call and access the combined dashboard related thereto.

In some embodiments, there may exist a one-to-one relationship between combined dashboard 505 and one of the access points 510, 515, and 520. However, this is not limited since in some embodiments and in some business contexts, access points 510, 515, and 520 may reference more than one combined dashboard.

FIG. 5 further depicts query definitions 525 that support dashboard 505. The query definitions define and correspond to the data visualization and the business action processes of combined dashboard 505. In some embodiments, there may exist a one-to-multiple relationship between combined dashboard 505 and query definition 525, since many queries may be called upon in the execution of dashboard 505.

Dashboard 505 is also supported by dashboard definition 530 that defines the attributes and rendering aspects of the combined dashboard. In some embodiments, there may exist a one-to-one relationship between combined dashboard 505 and dashboard definition 530. In some embodiments, dashboard definition 530 refers to dashboard definition 415 from operation of process 400. In some aspects, the dashboard definition is supported by a dashboard implementation file 540 (e.g., .swf) and multiple query definitions 535 that may include filter values pertaining to the particular combined dashboard 505, since many queries may be called upon in the dashboard at run time.

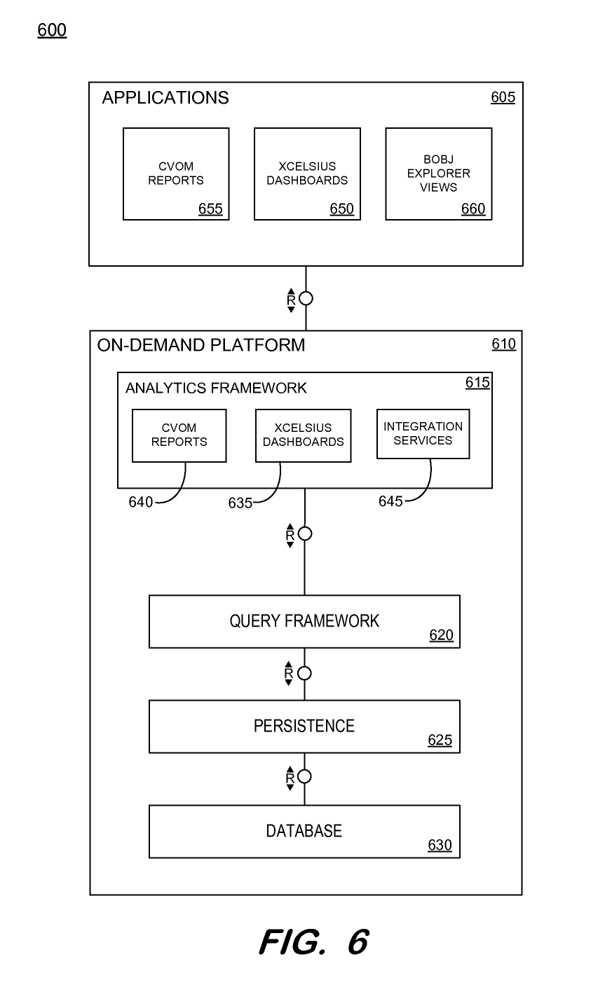

FIG. 6 is a detailed block diagram of system 600 according to some embodiments. System 600 includes client 605 running applications and on-demand enterprise platform 610. In some embodiments, business process platform 610 and client 605 may execute the functions described above in relation to processes and flows 200, 400, and 500.

Business process platform 610 may comprise a service-oriented architecture to provide services to client 605 and to other clients according to some embodiments. Client 605 may run and support a number of on-demand applications. Such applications may include a wide variety of business applications such as, for example, customer relationship management, e-sourcing, and other business processes. The on-demand platform 610 includes an analytics framework 615 to receive requests from client 605 and to forward the requests to appropriate work processes. For example, analytics framework 615 may receive a request associated with a combined dashboard according to aspects herein. Business process platform 610 includes a query framework 620 for executing queries defined in query definitions 535 in support of the combined dashboards herein and other functions, a persistence layer, framework, or service 625 to manage updates and interface with database 630 that stores data. It is noted that other components and services may be called upon and/or coupled in communication with system 600 to provide the systems and methods in some embodiments herein.

Regarding the combined dashboards created and presented for a user in accordance with some embodiments, a dashboard integration service 635 is provided (e.g., BusinessObjects Xcelsius). The dashboard integration service 635 may transform query data into a format (e.g., XML) for consumption by the combined dashboards. Additionally, dashboard integration service 635 may provide both general and specific functionality support for the combined dashboards, such as providing links to external locations/pages and internal pages.

A user may interact with client applications 605 to create and/or view combined dashboards. As illustrated in FIG. 6, the combined dashboards 650 may be accessed by a user to view and interact therewith in order to analyze and take business actions based on that analysis. The users interaction with the combined dashboards 650 may result in a connection being made with dashboard and integration services 645, which forms part of the analytics framework 615. Given the inclusion of both data visualizations and business process actions in the combined dashboards herein, the combined dashboards provide an analytical and a business intelligence service.

In some embodiments, the business process actions that may be defined, referenced, and performed according to the combined dashboards herein may be compound and time critical. Accordingly, a business process action may involve more than one action, API call, RFC, or web services. In some instances, the business process action may be time critical and as such, providing the business action process in the combined dashboard provides a more efficient methodology of implementing the business process actions.

In some embodiments, the business process actions contained in the combined dashboards do not increase data volume to the combined dashboard or system providing such dashboards during an initialization process. This is the case since query execution or API calls or web services or RFCs are triggered upon selection or other activation of the business process action by a user. Once the business process action is performed, the data associate with the data visualization aspects herein may be refreshed, either as needed or according to a rule or other implementation constraint (e.g., time—every 1 minute, etc.).

In some embodiments, the combined systems and dashboards herein may include or support a number of features. Some of the supported features include query message handling; system information support to provide system performance and system status such as timestamps of a last system data refresh; text localization support to translate labels, titles, subtitles, table headers, etc.; data transformations; and performance measures that provide insight into the performance of the systems and services. Some other aspects also supported include importing and exporting dashboards to source control systems; maintaining a consistency amongst the created combined dashboards; and supporting multiple connections to services, data stores, BOs (i.e., business objects), and selective queries for each connection.

Embodiments herein can facilitate any enterprise applications compatible with the various aspects herein. Accordingly, the present disclosure is not limited to a particular enterprise business process. The systems, methods, and services described herein may be implemented is ABAP, Java, C, .Net and other programming languages.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize that other embodiments may be practiced with modifications and alterations limited only by the claims.

What is claimed is:

1. A computer-implemented method comprising:
presenting, in a graphical user interface display panel, a graphic visualization of a business metric; and
presenting, in the same graphical user interface display panel, a mechanism to initiate a business process action associated with the visualized business metric.

2. A computer-implemented method according to claim 1, wherein the graphic visualization of the business metric is presented in a first display area of the graphical user interface display panel and the mechanism to initiate a business process action associated with the business visualized business metric is presented in a second display area of the graphical user interface display panel.

3. A computer-implemented method according to claim 1, further comprising presenting, in the graphical user interface display panel, a detailed graphic visualization of artifacts associated with the business metric.

4. A computer-implemented method according to claim 3, further comprising presenting, in the graphical user interface display panel, a graphic visualization of one or more of the artifacts associated with the business metric.

5. A computer-implemented method according to claim 1, wherein the mechanism to initiate a business process action associated with the visualized business metric invokes at least one of a application programming interface call, a web service, a remote function call, and a query.

6. A computer-implemented method according to claim 1, further comprising updating data associated with the graphical visualization of the business metric in response to performing the business process action associated with the visualized business metric and initiated by the business process action.

7. A computer-implemented method according to claim 6, wherein the updating data associated with the graphical visualization of the business metric includes updating all of the data associated with the graphical visualization of the business metric.

8. A computer-implemented method according to claim 1, further comprising:
executing a query to retrieve data associated with the graphic visualization of the business metric; and
transforming a result of the executed query to a format consumable by the graphical user interface display panel.

9. A computer-implemented method according to claim 1, further comprising:
storing the graphical user interface, including definitions to present the graphic visualization of the business metric and the mechanism to initiate the business process action associated with the visualized business metric, in a binary code.

10. A computer-readable medium storing program code executable by a computer to:
present, in a graphical user interface display panel, a graphic visualization of a business metric; and
present, in the same graphical user interface display panel, a mechanism to initiate a business process action associated with the visualized business metric.

11. A computer-readable medium according to claim 10, wherein the graphic visualization of the business metric is presented in a first display area of the graphical user interface display panel and the mechanism to initiate a business process action associated with the business visualized business metric is presented in a second display area of the graphical user interface display panel.

12. A computer-readable medium according to claim 10, further comprising code executable by a computer to present, in the graphical user interface display panel, a detailed graphic visualization of artifacts associated with the business metric.

13. A computer-readable medium according to claim 10, further comprising code executable by a computer to present, in the graphical user interface display panel, a graphic visualization of one or more of the artifacts associated with the business metric.

14. A computer-readable medium according to claim 10, further comprising code executable by a computer to invoke at least one of an application programming interface call, a web service, a remote function call, and a query in response to activating the mechanism to initiate the business process action associated with visualized business metric.

15. A computer-readable medium according to claim 10, further comprising code executable by a computer to update data associated with the graphical visualization of the business metric in response to performing the business process action associated with the visualized business metric and initiated by the business process action.

16. A computer-readable medium according to claim 15, wherein the updating of data associated with the graphical visualization of the business metric includes updating all of the data associated with the graphical visualization of the business metric.

17. A computer-readable medium according to claim 10, further comprising code executable by a computer to:
execute a query to retrieve data associated with the graphic visualization of the business metric; and
transform a result of the executed query to a format consumable by the graphical user interface display panel.

18. A computer-readable medium according to claim 10, further comprising code executable by a computer to store the graphical user interface, including definitions to present the graphic visualization of the business metric and the mechanism to initiate the business process action associated with the visualized business metric, in a binary code.

19. A system comprising:
an on-demand enterprise business platform; and
an application in communication with the on-demand enterprise business platform to:
present, in a graphical user interface display panel, a graphic visualization of a business metric; and
present, in the same graphical user interface display panel, a mechanism to initiate a business process action associated with the visualized business metric.

20. A system according to claim 19, wherein the graphic visualization of the business metric is presented in a first display area of the graphical user interface display panel and the mechanism to initiate a business process action associated with the business visualized business metric is presented in a second display area of the graphical user interface display panel.

21. A system according to claim 19, further comprising the application to present, in the graphical user interface display panel, a detailed graphic visualization of artifacts associated with the business metric.

22. A system according to claim 19, further comprising the application to present, in the graphical user interface display panel, a graphic visualization of one or more of the artifacts associated with the business metric.

23. A system according to claim 19, further comprising the application to update data associated with the graphical visualization of the business metric in response to performing the business process action associated with the visualized business metric and initiated by the business process action.
